(19) United States
(12) Patent Application Publication
(10) Pub. No.: US 2026/0365312 A1
(43) Pub. Date: Nov. 19, 2026

(54) FASTENING SYSTEM OF AN AIRCRAFT ENGINE HAVING AN INSTRUMENTED ROD

(71) Applicant: Airbus Operations SAS, TOULOUSE (FR)

(72) Inventors: Michael BERJOT, TOULOUSE (FR); Karounen VEERABADRAN, TOULOUSE (FR); Rémi LANSIAUX, TOULOUSE (FR); Laurent JAUFFRET, MARIGNANE (FR); Jean-Baptiste VIGNES, TOULOUSE (FR)

(21) Appl. No.: 19/675,975

(22) Filed: May 13, 2026

(30) Foreign Application Priority Data
May 15, 2025 (FR) FR2505183

(51) Int. Cl. B64D 27/40; B64D 45/00; G01L 5/1627

(52) U.S. Cl. CPC B64D 27/402; B64D 45/00; G01L 5/1627; B64D 2045/0085

(57) ABSTRACT

A fastening system for an aircraft and having a first chassis of a pylon of the aircraft, a second chassis of an engine of the aircraft and at least one instrumented rod having a rod with a first end fastened to the first chassis and a second end fastened to the second chassis, wherein the rod has two bars connecting the first end and the second end, and at least one strain gauge fastened to at least one of the two bars, wherein each strain gauge can be connected to a control unit of the aircraft.

### CROSS-REFERENCES TO RELATED APPLICATIONS

This application claims the benefit of French Patent Application Number FR2505183, filed on May 15, 2025, the entire disclosure of which is incorporated herein by way of reference.

### FIELD OF THE INVENTION

The present invention relates to a fastening system for aircraft comprising an instrumented rod implemented fastened between a chassis of a pylon and a chassis of an engine. The present invention also relates to an aircraft having at least one such fastening system.

### BACKGROUND OF THE INVENTION

Measuring the thrust of an aircraft engine is generally carried out on the ground on dedicated measurement benches, inter alia, by way of force balances. Measuring can also be carried out in flight, by fastening strain gauges to solid structural interface pieces, and this allows direct measurement.

These measurements using strain gauges make it possible to obtain a good estimation of the thrust of the engine, but there remains, however, a margin of error approximately of 10% over the measurement range.

It is therefore desirable to find an arrangement that makes it possible to improve this situation.

### SUMMARY OF THE INVENTION

An object of the present invention is to propose fastening system which comprises a rod that can be fastened between a pylon and an aircraft engine and that is equipped with strain gauges that make it possible to measure the forces.

For this purpose, there is proposed a fastening system for an aircraft and having a first chassis of a pylon of the aircraft, a second chassis of an engine of the aircraft and at least one instrumented rod having:
a rod having a first end fastened to the first chassis and a second end fastened to the second chassis, wherein the rod has two bars connecting the first end and the second end, and
at least one strain gauge fastened to at least one of the two bars, wherein each strain gauge is intended to be connected to a control unit of the aircraft.

With such instrumented rod, the sensitivity is increased, hence better precision in the results in the context of measurements on board an aircraft.

Advantageously, each bar is of rectangular section and has a strain gauge on each face.

The invention also proposes an aircraft having a control unit, a pylon with a first chassis, an engine with a second chassis and a fastening system according to one of the preceding variants, wherein each strain gauge is connected to the control unit.

### BRIEF DESCRIPTION OF THE DRAWINGS

The above mentioned features of the invention, along with others, will become more clearly apparent upon reading the following description of an exemplary embodiment, said description being given with reference to the appended drawings:

FIG. 1 is a side cross section of an aircraft having at least one fastening system according to the invention between a pylon and an engine,

FIG. 2 is a front view of a fastening system according to a first embodiment of the invention,

FIG. 3 is a cross-sectional view of a fastening system according to a second embodiment of the invention,

FIG. 4 is a perspective view of an instrumented rod according to the invention, and

FIG. 5 is a schematic depiction of an example of a hardware architecture of a control unit of the instrumented rod according to the invention.

### DETAILED DESCRIPTION OF THE PREFERRED EMBODIMENTS

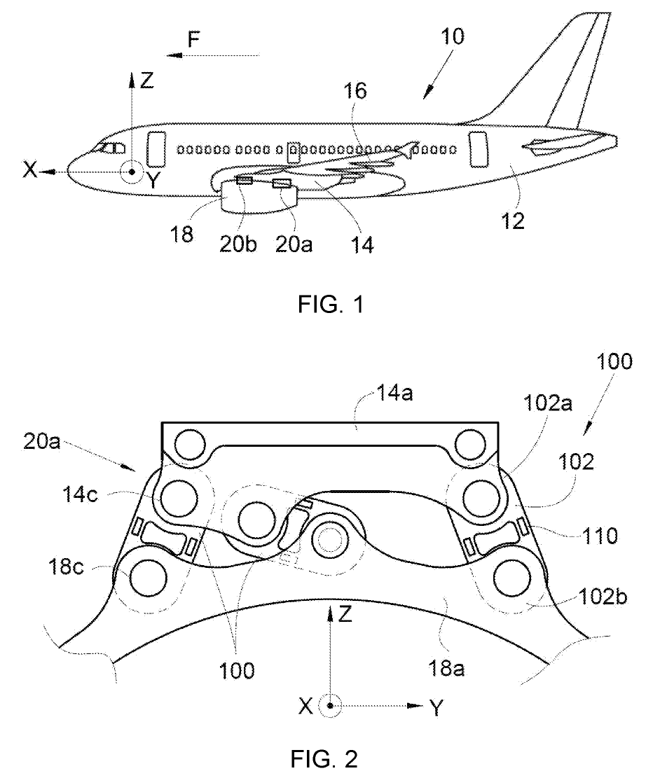

FIG. 1 shows an aircraft 10 that has a fuselage 12 to each side of which is fastened a wing 16. Each wing 16 supports at least one engine 18 that is fastened to the wing 16 by way of a pylon 14. The pylon 14 has a rigid structure forming a first chassis 14a-b and the engine 18 also has a rigid structure forming a second chassis 18a-b.

In the following description, terms relating to a position are considered in relation to an aircraft in a normal flight position, i.e., as shown in FIG. 1, and the “front” and “rear” positions are considered relative to the front and the rear of the aircraft and relative to the direction of forward movement F of the aircraft 10 when the engine 18 is in operation.

In the following description, and by convention, the X direction is the longitudinal direction of the aircraft, the Y direction is the transverse direction, which is horizontal when the aircraft is on the ground, and the Z direction is the vertical direction, which is vertical when the aircraft is on the ground, these three directions X, Y and Z being mutually orthogonal.

The engine 18 is fastened to the pylon 14 at the front by a front fastening system 20b and at the rear by a rear fastening system 20a.

Each fastening system 20a-b has a first chassis 14a (at the rear) and 14b (at the front) of the pylon 14 and a second chassis 18a (at the rear) and 18b (at the front).

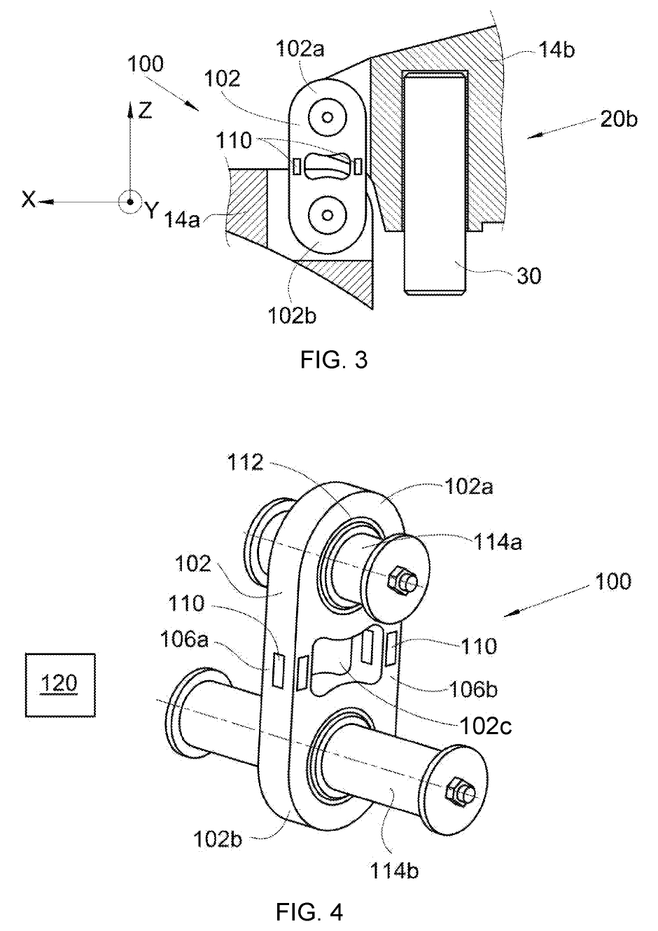

FIG. 2 shows an exemplary rear fastening system 20a and FIG. 3 shows an exemplary front fastening system 20b.

In the embodiment depicted in FIG. 2, the first chassis 14a takes the form of a transverse beam fastened conventionally to the lower part of the pylon 14 and the second chassis 18a takes the form of a ring (or a ring portion) that surrounds the engine 18.

In the embodiment depicted in FIG. 3, the first chassis 14b takes the form of a front part of the pylon 14 and the second chassis 18b takes the form of an upper part of the engine 18. In this embodiment, putting in place a vertical pin 30 (referred to as “spigot”), which will not be described in greater detail here since it does not fall within the boundaries of the invention, is also provided in this case.

FIG. 4 shows an instrumented rod 100 according to the invention.

In each of the fastening systems 20a-b, at least one instrumented rod 100 is fastened in an articulated manner between the first chassis 14a-b and the second chassis 18a-b. In the front fastening system 2a, there is a single instrumented rod 100 and, in the rear fastening system 2b, there are three instrumented rods 100. Of course, different arrangements are possible.

The instrumented rod 100 has a rod 102 having a first end 102a and a second end 102b. The first end 102a is fastened to the first chassis 14a-b of the pylon 14 and the second end 102b is fastened to the second chassis 18a-b of the engine 18.

Each fastening in this case takes the form of a pivot connection or of a ball joint connection and conventionally takes the form of a clevis connection.

At each end 102a-b, there is provided a bore 112 passing through the rod 102 and in which a mounting pin 114a-b is inserted. The mounting pin 114a-b also passes through bores 14c, 18c provided for this purpose in the first chassis 14a and the second chassis 18a.

The rod 102 has, in the middle thereof, i.e., between the first end 102a and the second end 102b, a cutout 102c and the first end 102a and the second end 102b are then connected by two bars 106a-b that are on either side of the cutout 102a.

The instrumented rod 100 also has at least one strain gauge 110 that is fastened to at least one of the two bars 106a-b and each strain gauge 110 is connected to a control unit 120 of the aircraft 10. The control unit 120 is in particular designed to record the values logged by each strain gauge 110. The control unit 120 may be a remote acquisition unit (RAU).

From these values, the control unit 120 may calculate the values of the thrust of the engine from pre-recorded formulae that are not described here since they do not form part of the invention.

With such instrumented rods 100, the measurements are taken as close as possible to the engine 18 and the particular shape of the rod 102 makes it possible to increase the sensitivity, hence better precision in the results.

According to one particular embodiment, each bar 106a-b has a rectangular section and a strain gauge 110 on each face. There are thus four strain gauges 110 per bar 106a-b for redundancy of the measurements.

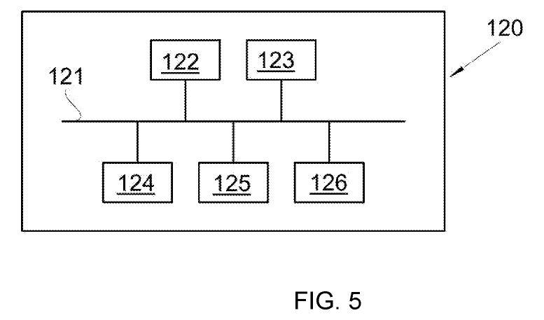

According to a particular embodiment depicted in FIG. 5, the control unit 120 has, connected by a communication bus 121: a processor 122 or CPU (central processing unit); a random access memory 123 (RAM); a read-only memory 124 (ROM) or Flash memory; a storage unit 125 such as a hard disk or a storage medium reader, such as an SD (secure digital) card reader; at least one communication interface 126 allowing for example the control unit to communicate with the strain gauges.

The processor is capable of executing, upon powering up, instructions loaded into the RAM from the ROM or Flash, from an external memory (not shown), from a storage medium (such as an SD card), or from a communication network. When the equipment is powered up, the processor is capable of reading instructions from the RAM and executing them. These instructions form a computer program that causes the implementation, by the processor, of all or some of the algorithms and steps described above.

All or some of the algorithms and steps described above may be implemented in software form by executing a set of instructions using a programmable machine, for example a DSP (digital signal processor) or a microcontroller, or be implemented in hardware form by a machine or a dedicated component, for example an FPGA (field-programmable gate array) or ASIC (application-specific integrated circuit).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fastening system for an aircraft comprising:
a first chassis of a pylon of the aircraft;
a second chassis of an engine of the aircraft; and
at least one instrumented rod having a rod with a first end fastened to the first chassis and a second end fastened to the second chassis, wherein the rod has two bars connecting the first end and the second end; and
at least one strain gauge fastened to at least one of the two bars, wherein each strain gauge is configured to be connected to a control unit of the aircraft.

2. The fastening system according to claim 1, wherein each bar of the two bars comprises a rectangular section and has a strain gauge on each face of the rectangular section.

3. An aircraft comprising:
a control unit;
a pylon with the first chassis;
an engine with the second chassis; and
the fastening system according to claim 1, wherein each strain gauge is connected to the control unit.
